(19) United States
(12) Patent Application Publication
(10) Pub. No.: US 2010/0308074 A1
(43) Pub. Date: Dec. 9, 2010

(54) LIQUID PUMP

(75) Inventors: Stefaan Jaak Vanquickenborne, Rijmenam (BE); Gunther Van Goolen, Capsugel Bornem (BE)

Correspondence Address: PFIZER INC;Mary J Hosley, 150 EAST 42ND STREET, MS: 150/02/E112, NEW YORK, NY, 10017-5612, US

(73) Assignee: Pfizer, Inc.

(21) Appl. No.: 12/675,139

(22) PCT Filed: Aug. 22, 2008
(86) PCT No.: PCT/IB08/02250

§ 371 Date: Feb. 25, 2010

Related U.S. Application Data
(60) Provisional application No. 60/969,187, filed on Aug. 31, 2007.

(30) Foreign Application Priority Data
Aug. 31, 2007 (EP) 07115456.1

(51) Int. Cl. B67D 7/64

(52) U.S. Cl. 222/1; 222/252

(57) ABSTRACT

A liquid pump for dispensing a liquid is provided. The pump comprises a body which defines a plurality of cylinders therein, each cylinder having located therein a respective piston, wherein each cylinder and respective piston is shaped and configured such that the fit between them substantially prevents leakage of the liquid to be dispensed. Such a liquid pump may be used to fill pharmaceutical dosage forms, such as capsules, with liquid pharmaceutical compositions.

The present invention relates to a liquid pump for dispensing a liquid into one or more receptacles. More specifically, the invention relates to a liquid pump comprising a plurality of cylinders housed within a body.

Known liquid dispensing pumps include at least one, and typically several, seals between each cylinder and piston. This causes a number of problems, not least when it comes to cleaning the pump and also inaccurate dosing of the liquid when the seals wear.

In addition, it is known to provide pumps which comprise multiple cylinders formed within a single body. However, these known pumps include at least one seal (and often multiple seals) between each cylinder and its respective piston in order to minimise leakage.

The problem of cleaning the pump becomes significant when the pump is used for relatively short runs of dispensing different liquids and needs to be cleaned between each run.

According to a first aspect of the invention, there is provided a liquid pump for dispensing a liquid, the pump comprising a body defining a plurality of cylinders therein, each cylinder having located therein a respective piston, wherein each cylinder and respective piston is shaped and configured such that the fit between them prevents leakage of the liquid to be dispensed.

Thus, the piston is shaped and sized such that no seals are necessary to prevent leakage of the liquid from the cylinder. In other words, the present invention provides a liquid pump which is free from a separate mechanical seal between each piston and its respective cylinder. The term “leakage” in this context is intended to refer to unintended or unwanted loss of the liquid to be dispensed from the cylinder, such as loss arising from the liquid being able to travel between the piston and cylinder wall. Furthermore, the term “prevent leakage” in the context of the invention is to be interpreted as preventing significant leakage (i.e. the fit between each piston and its respective cylinder substantially prevents leakage). The skilled person will appreciate that, over the course of a dispensing run, a very small, insignificant amount of liquid may be lost from the pump. Any such loss of liquid is insignificant in terms of the accuracy and reproducibility of the pump and is considered to be an acceptable loss.

By eliminating the need for separate mechanical seals between the pistons and cylinders, the cleaning of the pump between runs is greatly simplified. In addition, the accuracy of the pump is greatly improved, as variances introduced by the wearing of mechanical seals, such as rubber O-rings, are minimised. Furthermore, as the gap between each piston and cylinder is very small, abrasive particles are unable to enter the gap. Accordingly, the pistons and cylinders of the pump according to the invention are not subjected to wear caused by such abrasive particles being able to enter the gap. They therefore have a greater expected lifetime.

The skilled addressee will appreciate that the body is a single, unitary body.

The cylinder typically comprises an open end which permits axial movement of the piston within the cylinder, and a closed end which defines an end face of the cylinder.

In an embodiment of the invention, each piston includes a valve portion having a first position wherein the piston is capable of inducting the liquid to be dispensed into the cylinder and a second position wherein the piston is capable of dispensing the liquid from the cylinder to an outlet, and the valve portion is moveable between the first and second positions.

By having the valve portion formed as part of the pistons, the need for the pump to include a complicated valve arrangement external of the cylinders is avoided.

The valve portion may comprise a cut-away section of the cylindrical piston. For example the distal end of the piston (i.e. the end which in use remains within the cylinder) may have been machined or otherwise formed to remove an arc-shaped portion, thereby providing a part of the piston with a planar or flattened surface. In this embodiment, the planar or flattened valve portion of each piston, together with the respective cylinder wall defines a channel through which the liquid to be dispensed can flow. Thus, in the first position, the liquid to be dispensed can be drawn into the cylinder (i.e. induction) via a liquid inlet in fluid communication with the channel when the piston is driven towards the open end of the cylinder. The piston can then be moved to the second position (for example rotated), where the liquid inlet is closed by an arcuate portion of the piston and the channel defined by the planar or flattened valve portion of the piston is brought into fluid communication with a liquid outlet and the liquid is dispensed from the cylinder by driving the piston into the cylinder, towards its closed end.

In embodiments where each piston valve portion is moveable between the first and second positions by rotation, the pump further includes a rotational drive system capable of rotating the valve portions between the first and second positions. Typically, the rotational drive system will rotate all of the pistons simultaneously.

In a further embodiment of the invention the piston is made from a ceramic material and the cylinder walls are made from a ceramic material. In a still further embodiment, the ceramic material is a thermally stable ceramic material, for example a zirconium oxide based ceramic material. In other words, the ceramic material substantially does not shrink or expand upon being subject to the temperatures typically experienced within the liquid pump, for example between 0 and 150° C. Thus, the dimensions and shape of the piston and cylinder remain substantially constant upon heating or cooling and, in particular, remain substantially constant in the temperature range 0 to 150° C.

Previously, it has not been attempted to house more than one ceramic piston within a single body; known ceramic pumps for dispensing liquids comprise cylinders located within their own respective bodies, where each body includes a single respective cylinder and piston arrangement because of expected problems with piston breakage. However, the present inventors have found that by precisely specifying tolerances and using an optimum design drive coupling, the expected problems with piston breakage do not arise.

In order to avoid the need for one or more separate mechanical seals, the fit between each piston and cylinder must be such that the liquid to be dispensed is substantially not able to leak from the cylinder in use. Additionally, the friction between each piston and the cylinder should be minimised. It has been found that the use of a ceramic material, especially a thermally stable ceramic material, is able to maintain an optimum fit between each piston and cylinder over a desired range of operating temperatures. Furthermore, frictional forces between each piston and cylinder can be minimised by the use of a ceramic material for both the pistons the cylinder walls. In addition, ceramic materials are very hard and resistant to wear. Thus, the degradation in performance of the pump through wear of the pistons and/or the cylinder walls can further be minimised.

In order to provide cylinders having ceramic walls, the body of the liquid pump may be formed from a ceramic material which defines therein the cylinders (i.e. the cylinders are machined or otherwise formed within a ceramic body). Alternatively, ceramic liners (also known as ceramic sleeves) are provided in cylinders formed within (i.e. defined by) a non-ceramic body. For example, the body may be formed from a polymeric material or a metal such as aluminium, wherein the body defines a plurality of cylinders, each of which is provided with a ceramic liner. The cylinders within the non-ceramic body may be formed by machining, or by the molding (e.g. in the case of a polymeric body) or casting (e.g. in the case of a metallic body) step of forming the body.

In embodiments where the body is non-ceramic and is provided with ceramic liners for the cylinders defined therein, the liners may be releasably coupled to the body. By having the ceramic liners releasably coupled to the body, the pump becomes easier to disassemble for cleaning and it becomes possible to replace a damaged or worn cylinder liner without having to replace the entire body.

In a further embodiment, the body includes one or more temperature control circuits. The temperature control circuit may be in the form of an electrical resistance heater embedded within the body or it may be in the form of fluid conduits located or defined within the body. In embodiments which include fluid conduits within the body, the temperature control circuit may further comprise a temperature control fluid inlet and a temperature control fluid outlet, wherein the temperature of the body is controlled by the flow therethrough of the temperature control fluid.

An advantage of using a temperature control fluid to control the temperature of the pump is that the pump may be heated or cooled, depending on the fluid being used. In such embodiments, the body of the liquid pump may be maintained at a temperature other than room temperature. For example, the body may be heated by passing a heated fluid through the conduits defined by or located within the body. A skilled person will appreciate that the viscosity of certain liquids can be modified by heating them. Typically, the viscosity of a liquid decreases with increasing temperature. Thus, a normally viscous liquid may be dispensed more easily by using a heated pump. By “more easily”, it will be apparent to those skilled in the art that less force is needed to draw the fluid into the cylinder and less force is needed to dispense or expel the liquid from the cylinder.

Alternatively, it may be useful to cool the body by passing a coolant fluid through it. For example, it might be desired to increase the viscosity of the liquid to be dispensed, or the liquid to be dispensed may be sensitive to heat.

In a further embodiment of the invention, the pump further comprises a piston drive system coupled to the pistons to cause the pistons to move axially within their respective cylinders.

The drive system may control the speed and/or force of the inlet stroke, i.e. the induction of the fluid to be dispensed into the cylinder. Additionally or alternatively, it may control the speed and/or force of the ejection stroke, i.e. the dispensing of the liquid from the cylinder. In an embodiment of the invention, the drive system controls the speed and force of both the inlet and ejection strokes.

In an embodiment of the invention, the piston drive system also drives each piston to rotate within its respective cylinder

The drive system may comprise a single drive source, e.g. an electric motor, a servo motor, a hydraulic drive source or a pneumatic drive source, or it may comprise two or more drive sources. In embodiments where the pump includes two or more drive sources, one drive source may effect the inlet stroke and a second drive source may effect the ejection stroke. Additionally or alternatively, one drive source may effect axial movement of the pistons and the second drive source may effect rotational movement of each piston within its respective cylinder.

The drive sources may include one or more respective controllers which are adapted to control the force exerted by the relevant drive source and/or the speed or rate at which the pistons are moved within their cylinders. In certain embodiments of the invention, the one or more controllers are continuously variable controllers which are able to control the relevant drive sources according to the flow characteristics of the fluid to be dispensed.

The drive system may include a plurality of drive shafts, each operatively coupled to a respective piston.

In a further embodiment of the invention, each piston is releasably coupled to the drive system. Optionally, this includes each piston being releasably coupled to a respective drive shaft.

Having the pistons releasably coupled to the drive system again aids the cleaning of the pump between dispensing runs, as it makes the pump easier to disassemble and reassemble and therefore quicker and easier to clean.

In an embodiment of the invention, each piston is releasably coupled to the drive system and the coupling is configured to permit the release of the piston from the drive system by movement of the piston in a radial direction with respect to its longitudinal axis. In a further embodiment, substantially no play is permitted between the drive system and the piston in the axial direction of the piston. The term “substantially no play” should be construed in the context of the invention as meaning that less than 10 micrometers (10 μm) of relative axial movement is permitted.

It has been found that by allowing a degree of play in a transverse direction, but substantially no play in an axial direction, the non-axial forces exerted on the pistons are minimised and small differences in the alignment of the pistons with the drive system can be accommodated. This minimises the risks of piston breakage and allows for multiple pistons to be housed in a single body.

In a further embodiment of the invention, the body of the pump is moveable relative to the drive system, whereby the pistons may be released from the drive system whilst still located within their respective cylinders. The body typically moves transversely to the longitudinal axes of the cylinders (where the cylinders are arranged to be parallel to each other), wherein the transverse movement relative to the drive system decouples the pistons from the drive system and permits the subsequent removal of the pistons from their respective cylinders.

By providing a releasable coupling which permits movement in a direction transverse to the longitudinal axis of the piston, but substantially prevents movement in the axial direction, the accuracy of the pump may be maintained. Thus, each inlet stroke will draw a known volume of liquid into the cylinder and each ejection stroke will dispense that volume. In this way, it is possible to dose accurately and repeatably a plurality of receptacles with a known volume of the liquid

The releasable coupling between each piston and the drive system may be achieved by providing the piston with a hook-shaped connector which is adapted to cooperate with a respective bar carried by the drive system, or a drive shaft thereof. The reverse arrangement, i.e. hooks on the drive system and respective bars on the pistons, is also contemplated.

To assist with the alignment of the hook and bar components, the hook may include a tapered opening. In embodiments of the invention, the hook further comprises a bar contact portion which comprises a channel having a width substantially equal to the diameter of the bar. The bar is located within the channel in use and the channel is sized such that movement of the piston relative to the drive system in an axial direction is substantially prevented. In other words, there is substantially no play between the piston and the drive system in the axial direction of the piston.

The hook and bar components may be arranged such that they are also capable of transmitting torque (i.e. a rotational force) to the piston such that it can rotate within its respective cylinder.

In an embodiment of the invention, each cylinder includes a liquid outlet in fluid communication with a respective liquid dispensing nozzle, whereby the liquid ejected from each cylinder may be separately and individually dispensed via the dispensing nozzle to a respective receptacle. Alternatively, the liquid outlets of the cylinders may all be in fluid communication with a common dispensing manifold, whereby the liquids ejected from the cylinders are mixed with each other in the manifold. In a still further embodiment, the liquid outlets of two or more cylinders may be combined within a common conduit, such that the liquids ejected from the two or more cylinders may be combined and dispensed as a mixture.

Thus, the pump of the invention may be used to dispense multiple doses of a known volume of liquid into respective receptacles or it may be used repeatedly to mix known volumes of different liquids into a single receptacle.

Accordingly, the pump of the invention may include liquid inlets which are all in fluid communication with (i.e. connected to) a common liquid source. Alternatively, the inlet for each cylinder may be in fluid communication with a respective liquid source.

The pumps of the invention are advantageously used to dispense liquids very accurately. This means that each cylinder of the pump is able to dispense repeatedly and accurately a desired volume of liquid. The improved accuracy, repeatability and ease of cleaning result in a pump which may be used, for example, in the filling of pharmaceutical capsules with liquid formulations.

According to a second aspect of the invention, there is provided a method of dispensing a liquid, the method including drawing a liquid to be dispensed into the liquid pump as defined in any embodiment or combination of embodiments of the first aspect of the invention as defined above and dispensing it from the pump into one or more respective receptacles aligned with liquid dispensing nozzles from the pump.

In an embodiment of the invention, each piston includes a valve portion having a first position wherein the piston is capable of inducting the liquid to be dispensed into the cylinder from a liquid source, and a second position wherein the piston is capable of dispensing the liquid from the cylinder to an outlet, and the method comprises driving each piston partially out of its respective cylinder with the valve portion in the first position to draw the liquid to be dispensed into the respective cylinders, rotating each piston such that the valve portion moves from the first position to the second position and driving each piston into its respective cylinder with the valve portion in the second position to dispense the liquid from the cylinder to the outlet.

The various embodiments and features of the invention as defined above may be combined with one or more other embodiments or features of the invention unless expressly stated otherwise. Thus, the term “embodiment of the invention” should be construed as “embodiment of the invention as defined in any aspect or embodiment hereinabove”. Similarly, embodiments described with reference to one aspect of the invention are equally applicable to the other aspects of the invention, unless expressly stated otherwise. Accordingly, an embodiment described in relation to the first aspect of the invention may also constitute an embodiment of the second aspect of the invention or vice versa.

As used herein, the following terms should be considered to have the meaning indicated:

The term “fit” refers to the relative configuration and dimensions of each piston and its respective cylinder, such that a gap is defined between the outwardly facing surface of the piston and the internal wall of the cylinder. The gap may be defined as the difference between the diameters of a cylinder and its respective piston (i.e. the internal diameter of the cylinder and the external diameter of the piston). Using this definition, the difference between the diameters of each piston and cylinder in an embodiment of the invention is 0.5 to 5 μm. In a further embodiment, the difference in the diameters is 0.7 to 2 μm. In a still further embodiment, the difference is 0.8 to 1.2 μm.

The terms “inlet stroke”, “induction”, “drawn into”, “aspiration” and the like used with reference to the cylinders being charged with the liquid to be dispensed are intended to have the same meaning (i.e. are used interchangeably). Similarly, the terms “expel” and “dispense” are used synonymously, as are the terms “speed” and “rate” with respect to the drive system.

An embodiment of the invention will now be described in detail, by way of example only, with reference to the accompanying drawings, in which:

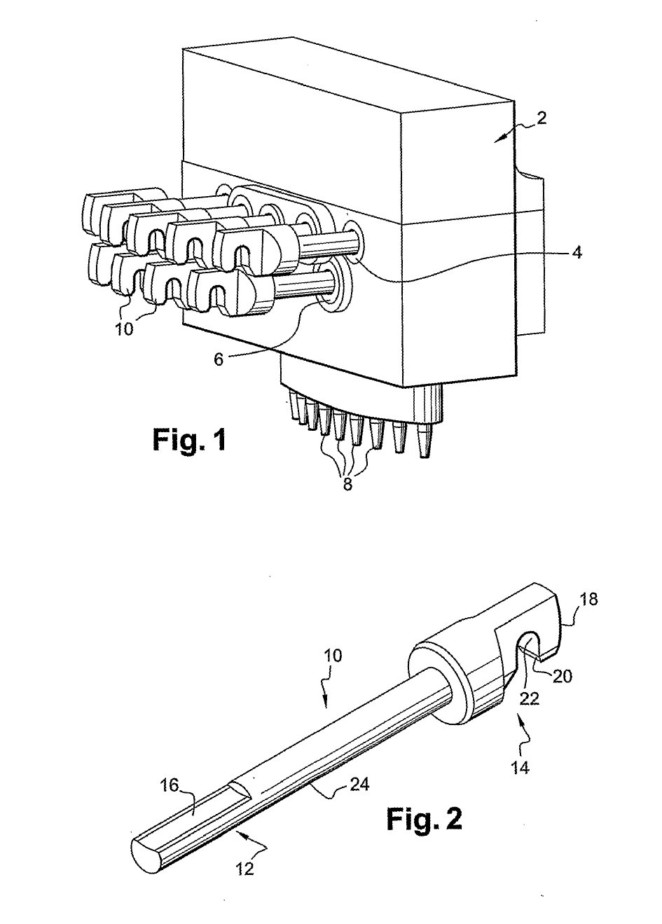

FIG. 1 is a perspective view of a pump body with pistons located within respective cylinders;

FIG. 2 is a perspective view of a piston;

FIG. 3 is a cross-sectional view, in an axial plane, of a piston located within a respective cylinder of the pump illustrated on FIG. 1;

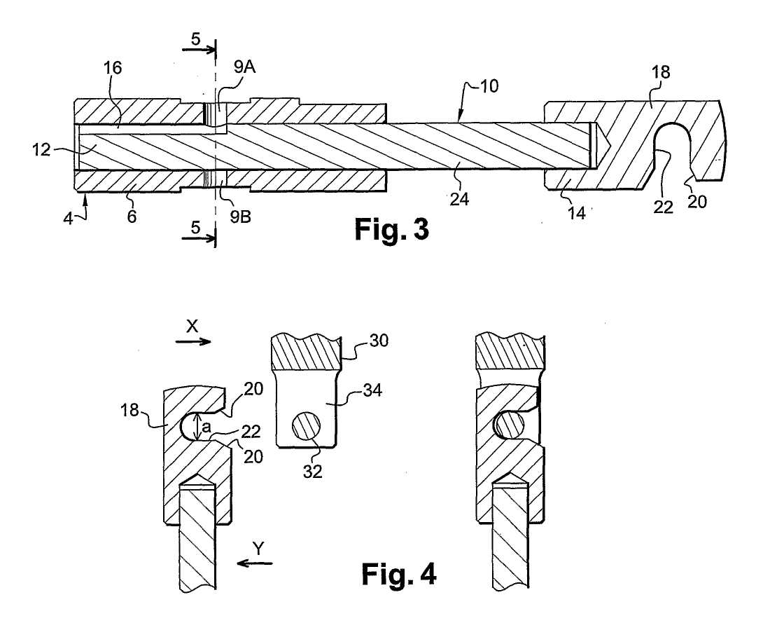

FIG. 4 is a cross sectional view of the connecting end of a piston and the corresponding end of a drive shaft; and

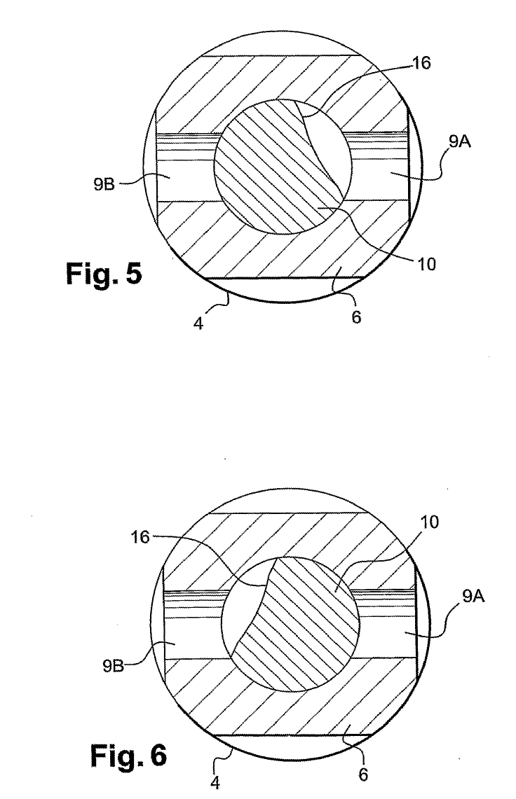

FIGS. 5 and 6 are cross-sectional views, along the line 5-5, of the assembly of FIG. 3, respectively in a first position of aspiration of the liquid to be dispensed and in a second position of dispensation of the liquid.

A body 2 of a pump according to the invention is shown in FIG. 1. The body 2 is formed as a one piece construction from polyethylene terephthalate (PET) and defines therein a number of cylinders 4. Nine cylinders 4 are depicted in FIG. 1, but it will be apparent to a skilled person that more or fewer cylinders 4 may be formed within the body 2.

Each cylinder includes a ceramic liner 6 consisting of a sleeve formed from a zirconium oxide ceramic material which has been enriched with magnesium oxide (available from Friatec AG; Mannheim, Germany). The liners 6 are retained within the cylinders 4 by a locking key (not shown).

The closed end of the cylinders 4 is formed by an end plate (not shown) releasably coupled to the body 2. Thus, the end plate may be removed for cleaning of the pump.

The body 2 further includes a plurality of dispensing nozzles 8 for dispensing a liquid from the cylinders 4 of the pump into respective receptacles.

The dispensing nozzles 8 are joined to outlet ports 9B of the cylinders 4 by outlet conduits (not shown) defined within the pump body 2.

The body 2 further includes a liquid inlet (not shown) which supplies the cylinders 4 with the liquid to be dispensed via inlet conduits (also not shown) defined within the body 2 and inlet ports 9A defined in the cylinders 4. The liquid inlet is adapted to be connected to a source or reservoir of the liquid to be dispensed.

In this embodiment, all of the cylinders 4 are supplied with the same liquid, which is individually dosed to individual receptacles from the cylinders 4. However, it will be apparent to the skilled person from the foregoing that each cylinder 4 may be connected to its own respective source of a liquid to be dispensed, such that each cylinder 4 or groups of cylinders 4 may dispense a different liquid.

Additionally provided within the body 2, but not shown in FIG. 1 is a temperature control circuit defined within the body 2. The temperature control circuit includes a fluid inlet, a fluid outlet and a conduit therebetween located or defined within the body 2 such that a temperature control fluid can flow through the body 2 and maintain the body 2 at a desired temperature. The temperature of the control fluid is controlled in a known manner.

It will be appreciated by the skilled person that it is well known to form or locate conduits within a body. This may be achieved by various different well known techniques.

As an alternative to the temperature control circuit comprising fluid-carrying conduits, it may instead comprise resistive wires embedded within the body, wherein the wires may be connected to an electrical power source to heat the body 2.

The piston 10 is shown in more detail in FIGS. 2 and 3. As shown on FIG. 3, located within each cylinder is a respective piston 10.

The piston 10 has a distal end 12 which in use remains within the cylinder 4 of the body 2. Opposite the distal end (i.e. the proximal end) is a connector portion 14 for connecting the piston to a respective drive shaft 30 (shown in FIG. 4).

The piston includes a shaft 24 formed from an yttrium oxide enriched zirconium oxide ceramic material (known as “nanocare” and available from Friatec AG; Mannheim, Germany). The distal end of the shaft 24 is formed to provide a planar valve portion 16. This may be achieved, for example, by machining the distal end of the shaft 24 to remove an arcuate portion of the ceramic material.

The shaft 24 is fixed to the connector portion 14 of the piston 10 by any suitable means, such as an adhesive, a mechanical fixing or by providing a frictional fit between them.

The proximal end 18 of the connector portion 14 is hook shaped and defines an opening having tapered sides 20 and a drive shaft retaining channel 22. The drive shaft retaining channel 22 has opposed sides having a predefined gap a therebetween.

The drive shaft retaining channel 22 is adapted to engage a connector bar 32 of the drive shaft 30. The gap a is sized to be about 1 μm (1 micrometer) greater than the diameter of the connector bar 32. In this way, there is substantially no axial play between the drive shaft 30 and the piston 10 in use, but it is nevertheless possible to couple and decouple easily the drive shaft 30 and the piston 10.

The connector bar 32 is fixed between opposed walls 34 of a U-shaped end of the drive shaft 30.

The drive shaft 30 is operably connected at its other end to a drive system (not shown). The drive system may be a conventional drive system which comprises a drive source, such as a servo motor, a pneumatic system or a hydraulic system; and a controller, such as a continuously variable controller to control the rate and/or force of the inlet/ejection strokes. It will be apparent to the skilled person that the drive system may comprise separate drive sources, for example, one to drive the inlet stroke and the other to drive the ejection stroke. Such an arrangement is well known and need not be described herein in detail.

Additionally, the drive system includes a rotational drive source for rotating simultaneously each of the pistons 10 within their respective cylinders 4. This causes the planar valve portion 16 of each piston 10 selectively to permit inlet (FIG. 5) or ejection (FIG. 6) of the fluid to be dispensed. The rotational movement is transmitted to the pistons via their respective hook and bar coupling. Again, the rotational drive source is well known and need not be described in detail herein.

In use, each of the piston connector portions 14 are connected to a respective drive shaft 30 by aligning the drive shaft retaining channel 22 with the connector bar 32 and moving the piston 10 relative to the drive shaft 30 in the direction X shown in FIG. 4.

Once the pistons 10 are engaged with their respective drive shafts 30, the liquid inlet of the body 2 is connected to a source of the liquid to be dispensed, such as a reservoir of the liquid, and the temperature control fluid inlet and outlet are connected to the flow and return sides of a temperature control fluid supply system. The temperature control fluid is controlled by the control fluid supply system and is passed through the body 2 until the desired temperature is achieved.

With the pistons 10 arranged with their planar valve portions 16 in an inlet position, i.e. with the arcuate portion of the distal end 12 closing the liquid outlet port from the cylinder and the planar valve portion 16 defining a channel between the piston 10 and the cylinder 4, the channel being adjacent the liquid inlet port of the cylinder 4, the pistons 10 are pulled partly out of their cylinders 4 by the drive system.

This draws the liquid to be dispensed into the cylinder 4 via the liquid inlet, the inlet conduits and the liquid inlet port.

Once the desired volume of liquid has been drawn into each cylinder 4, the pistons 10 are rotated by the drive system to an ejection position. In the ejection position, the arcuate portion of the distal end 12 closes the liquid inlet port and the planar valve portion 16 defines a channel in fluid communication with the liquid outlet port. The pistons 10 are then urged back into their respective cylinders 4 with the effect that the liquid drawn into the cylinders 4 is ejected therefrom and is dispensed into receptacles via the outlet ports, the outlet conduits and the dispensing nozzles 8.

To clean the pump, the liquid inlet is disconnected from the liquid source and the temperature control fluid inlet and outlet are disconnected from the control fluid system. The pistons 10 are then disconnected from their respective drive shafts 30 by movement of the body in the Y direction as shown in FIG. 4. The pistons 8 can then be removed from their cylinders 4 and cleaned. The end plate of the body 2 may be removed for cleaning, as may the cylinder liners 6.

The absence of separate mechanical seals, such as O-ring seals, means that the pump can be quickly and easily disassembled and reassembled, e.g. for cleaning.

1. A liquid pump for dispensing a liquid, the pump comprising a body defining a plurality of cylinders therein, each cylinder having located therein a respective piston, wherein each cylinder and respective piston is shaped and configured such that the fit between them prevents leakage of the liquid to be dispensed and wherein the pistons are made from a ceramic material.

2. The liquid pump according to claim 1, wherein each piston includes a valve portion having a first position wherein the piston is capable of inducting the liquid to be dispensed into the cylinder and a second position wherein the piston is capable of dispensing the liquid from the cylinder to an outlet, and the valve portion is moveable between the first and second positions.

3. The liquid pump according to claim 2, wherein the valve portion is moved between the first and second positions by rotation and the pump includes a rotational drive system operatively connected to each piston to rotate the valve portion between the first and second positions.

4. The liquid pump according to claim 1, wherein the body is a ceramic body.

5. The liquid pump according to claim 1, wherein the body is formed from a non-ceramic material, and each cylinder includes a ceramic liner.

6. The liquid pump according to claim 1, wherein the body includes one or more temperature control fluid conduits defined therein, a temperature control fluid inlet and a temperature control fluid outlet, wherein the temperature of the body is controlled by the flow therethrough of the temperature control fluid.

7. The liquid pump according to claim 1, further comprising a piston drive system coupled to the pistons to cause the pistons to move axially within their respective cylinders.

8. The liquid pump according to claim 7, wherein each piston is coupled to a respective drive shaft of the drive system.

9. The liquid pump according to claim 7, wherein each piston is releasably coupled to the drive system.

10. The liquid pump according to claim 9, wherein the coupling is configured to permit the release of the piston from the drive system by movement of the piston relative to the drive system transversely to the longitudinal axis of the piston, and that substantially no play is permitted between the drive system and the piston in an axial direction.

11. The liquid pump according to claim 10, wherein the body is adapted for movement relative to the drive system, whereby all of the pistons are releasable simultaneously from the drive system.

12. The liquid pump according to claim 10, wherein each piston includes a hook-shaped connector adapted to releasably couple with a respective bar carried by the drive system, the hook-shaped connector including a tapered opening to allow correct alignment of the bar within the connector and bar contact portion having a width equal to the diameter of the bar to prevent axial play between the bar and the hook-shaped connector in use.

13. A method of dispensing a liquid, the method including drawing a liquid to be dispensed into the liquid pump as defined in claim 1 and dispensing it from the pump into respective receptacles aligned with liquid outlets from the pump.

14. The method according to claim 13, wherein each piston includes a valve portion having a first position wherein the piston is capable of inducting the liquid to be dispensed into the cylinder and a second position wherein the piston is capable of dispensing the liquid from the cylinder to an outlet, the method comprising driving each piston partially out of its respective cylinder with the valve portion in the first position to draw the liquid to be dispensed into the respective cylinders, rotating each piston such that the valve portion moves from the first position to the second position and driving each piston into its respective cylinder with the valve portion in the second position to dispense the liquid from the cylinder to the outlet.

15. The method according to claim 13, wherein the pump body is maintained at a desired temperature by pumping a temperature control fluid through one or more conduits formed in the body.

16. A use of a liquid pump as defined in claim 1 to fill oral dosage forms with a liquid pharmaceutical or nutraceutical composition.

17. The use according to claim 16, wherein the oral dosage form is a capsule.
